(19) United States
(12) Patent Application Publication
(10) Pub. No.: US 2008/0295018 A1
(43) Pub. Date: Nov. 27, 2008

(54) Apparatus, method and computer program product providing an adaptive forward button for a browser application

(75) Inventors: Mikko A. Nurmi, Tampere (FI); Christian Kraft, Frederiksberg (DK); Erik Anderson, Turku (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/807,273

(22) Filed: May 24, 2007

(51) Int. Cl. G06F 3/048

(52) U.S. Cl. 715/780

(57) ABSTRACT

Disclosed are apparatus, computer program products, methods and a user interface that operate in conjunction with a forward button or control. In accordance with the exemplary embodiments of this invention a method includes, during a first instance of operation of an application, and in response to linking to a second page from a first, displayed page, saving an identification of the second page in association with an identification of the first page; and during a second instance of operation of the application, after termination of the first instance of operation, and in response to activating a forward button when the first page is displayed, retrieving the saved identification and automatically linking to the second page. A further method operates in response to a user closing a displayed web page, for storing information descriptive of a location of a cursor within the web page and, in response to the web page subsequently being opened, for accessing the stored information and displaying the web page so as to include the cursor positioned at the same location. In the exemplary embodiments the first and second pages may be web pages, or they may be at least one of files and file folders, as two non-limiting examples.

### TECHNICAL FIELD

The exemplary and non-limiting embodiments of this invention relate generally to systems, methods, devices and computer program products providing browser and other page-based applications and, more specifically, relate to techniques to operation of a control causing a forward action in a browser or other type of application.

### BACKGROUND

FIG. 1 illustrates a portion of a conventional display 10 that shows a currently displayed page 12, such as one received from a server via the Internet. In a typical browser application embodiment there will be a plurality of information fields and controls, such as those shown in a task bar 14. The information fields and controls can include an address field 16 for entering and displaying a network address (e.g., http://www.anyaddress . . . ) that is associated with the displayed page 12. The controls can include one or more buttons 18A, 18B, such as a home button, a stop button, a refresh button, etc., that are displayed typically through the use of appropriate icons. The controls typically also include a back button 20, typically displayed as a left-pointing arrow, and, of particular interest herein, a forward button 22 that is typically displayed as a right-pointing arrow.

In current browsers the forward button 22 is not used nearly as much as the back button 20. One reason for this is that normally a user moves from one page to another using a familiar page hierarchy. In a typical use case it is fairly rare for the user to move to a second web page from the current (first) web page, then by using the back button 20 to move back to the first web page, and then to use the forward button 22 to move once more to the second web page. This type of typical use pattern limits the utility of the forward button 22.

Additionally, a number of challenges can be presented when operating with a display screen having a small display surface area, such as may be found in portable, battery powered devices such as cell phones and PDAs. These challenges relate generally to providing an easily readable display of web pages and other information that enables ease of use and ready navigation by the user through displayed web pages.

### SUMMARY OF THE EXEMPLARY EMBODIMENTS

The foregoing and other problems are overcome, and other advantages are realized, in accordance with the non-limiting and exemplary embodiments of this invention.

In a first aspect thereof the exemplary embodiments of this invention provide a method wherein during a first instance of operation of an application, and in response to linking to a second page from a first, displayed page, saving an identification of the second page in association with an identification of the first page; and during a second instance of operation of the application, after termination of the first instance of operation, and in response to activating a forward button when the first page is displayed, retrieving the saved identification and automatically linking to the second page.

In another aspect thereof the exemplary embodiments of this invention provide a method that includes, in response to linking to a second page from a first, displayed page, saving an identification of the second page in association with an identification of the first page; in response to linking to a third page from the first, displayed page, saving an identification of the third page in association with an identification of the first page; and in response to activating a forward button when the first page is displayed, retrieving the saved identifications and displaying the identifications for enabling a selection of one of the second or third pages to link to.

In a further aspect thereof the exemplary embodiments of this invention provide an apparatus that includes a display, a memory, a network interface and a data processor configured to operate under control of a stored program to display information on the display, where the information comprises at least pages received through the network interface. The data processor is further configured to store in the memory, in association with an identification of a first page, an identification of each of a plurality of second pages that are linked to from the first page, and, in response to an activation of a forward control when the first page is displayed, to display at least some of the saved identifications for enabling a selection of one of the plurality of second pages to link to.

In another aspect thereof the exemplary embodiments of this invention provide a computer program product embodied in a tangible memory medium and comprising program instructions that when executed by a data processor result in operations that comprise, in response to linking to individual ones of a plurality of second pages from a first, displayed page, saving an identification of each of the plurality of second pages in association with an identification of the first page; and in response to subsequently activating a forward button when the first page is displayed, displaying at least some of the saved identifications for enabling a selection of one of the plurality of second pages to link to.

In a still further aspect thereof the exemplary embodiments of this invention provide a user interface that comprises means for displaying pages to a user; means for storing an identification of a plurality of second pages in association with an identification of a first page, where the plurality of second pages are those previously linked to from the first page and means, responsive to activation of a forward button when the first page is displayed, for accessing said storing means to retrieve the identifications of the plurality of second pages and for displaying at least some of the identifications using said displaying means.

In one further aspect thereof the exemplary embodiments of this invention provide a method that operates, in response to each access of different ones of second information items from a first, displayed information item, to save an identification of each of the second information items in association with an identification of the first information item and, in response to activation of a forward user interface control when the first information item is displayed, to display saved identifications for enabling a selection to be made of one of the second information items.

In another aspect thereof the exemplary embodiments of this invention provide a method, that comprises, in response to a user closing a displayed web page, storing information descriptive of a location of a cursor within the web page and, in response to the web page subsequently being opened, accessing the stored information and displaying the web page so as to include the cursor positioned at the same location.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 illustrates a portion of a conventional display that includes a forward button.

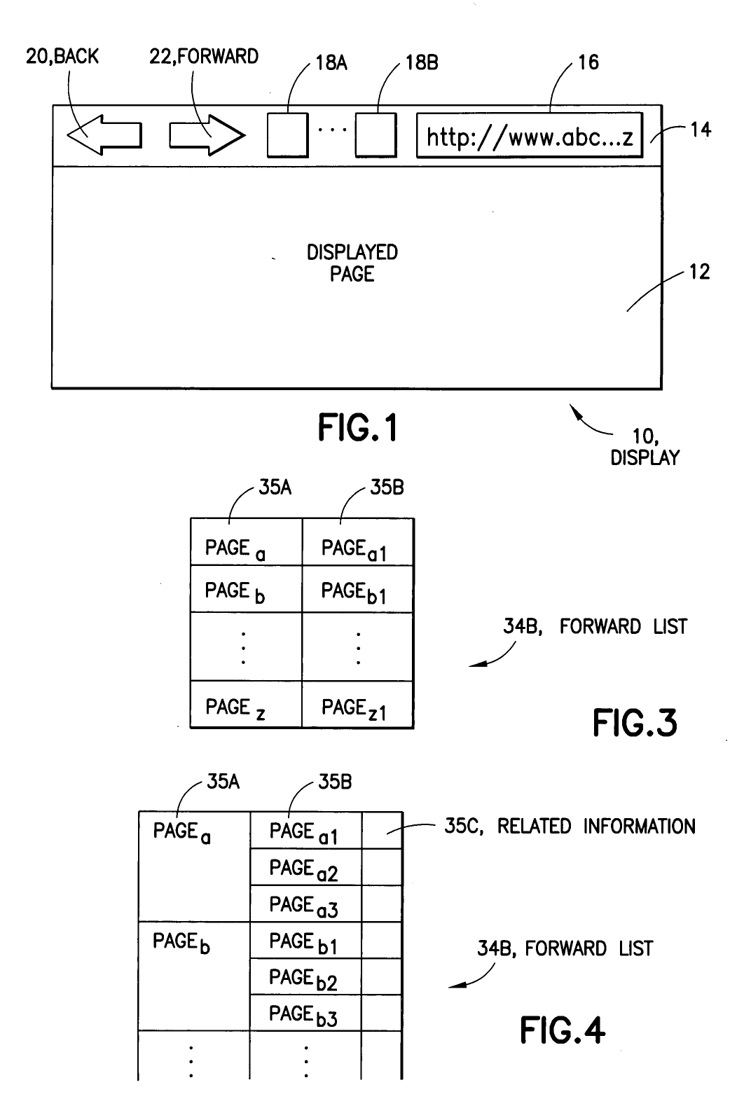

FIG. 2 shows an exemplary hardware/software environment wherein embodiments of this invention may be implemented.

FIGS. 3 and 4 each illustrate an embodiment of a forward list that may be stored in the memory shown in FIG. 2.

FIG. 5 shows a portion of a display and a drop down list presented in response to the activation of the forward button, in accordance with an exemplary embodiment of this invention.

FIGS. 6A, 6B and 6C are logic flow diagrams descriptive of methods in accordance with the exemplary embodiments of this invention.

FIGS. 7 and 8 depict additional exemplary hardware/software environments wherein further embodiments of this invention may be implemented.

### DETAILED DESCRIPTION

The exemplary embodiments of this invention provide in one aspect thereof an ability to use the forward button 22 in a novel manner, where a software application, such as one embodied in the browser application, determines a most used link or links from a current web page (based on historical and/or other information) and offers the user the ability to move to at least one historically most used link (web page) by using the forward button 22. The exemplary embodiments also permit moving to a specific part of a web page (e.g., similar to a login formula).

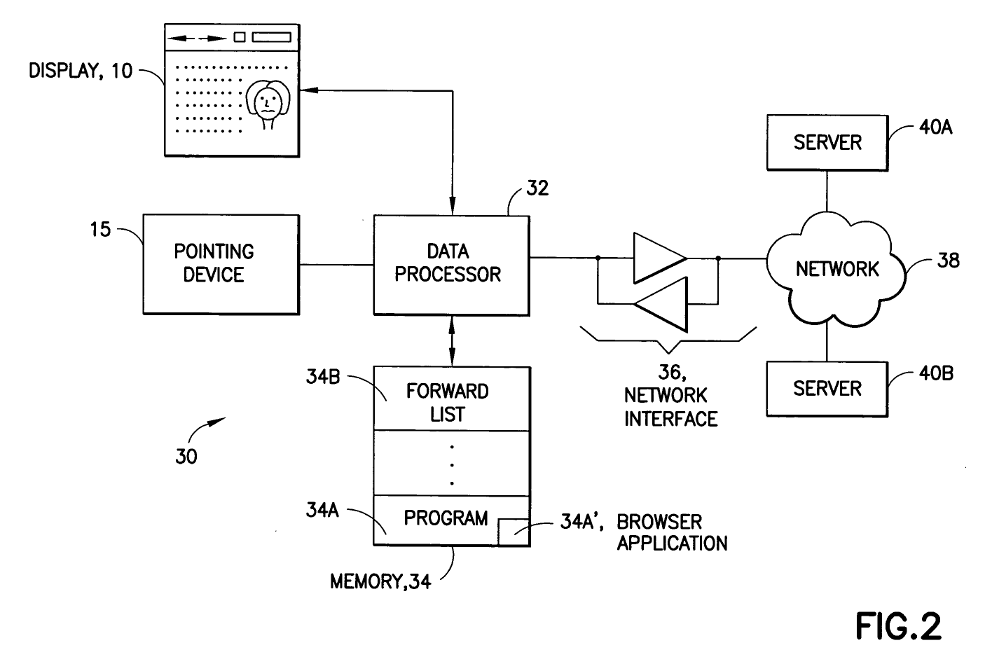

Reference is made to FIG. 2 for showing one non-limiting hardware/software environment wherein the exemplary embodiments of this invention may be implemented. A system or device 30 includes the display 10, a controller such as a data processor 32 bidirectionally coupled with at least one memory 34, and some suitable network interface 36. The network interface 36 enables communication with a network 38, such as the Internet, or a local area network (LAN), such as a wireless local area network (WLAN). Reachable through the network 38 are one or more addressable servers 40A, 40B capable of providing displayable information (e.g., web pages). Coupled with the data processor 32 may be a pointing device 15, such as a mouse or a trackball, or any suitable type of means for a user to indicate and select a region on the display surface of the display 10. Other non-limiting types of pointing devices 15 include an eye tracker, a voice recognition module, or a keypad or a keyboard. In other embodiments the surface of the display 10 may be touch sensitive so as to respond to a presence of a stylus and/or the user's finger.

The memory 34 includes storage for program instructions 34A, which may include a browser application program (referred to as browser application 34A′ hereafter) that operates in accordance with the exemplary embodiments of this invention. For this purpose the memory 34 also includes storage for a forward list 34B, wherein a historical record is maintained for links requested from various web pages viewed by the user, as described in further detail below.

The memory 34 may be implemented with semiconductor memory, flash memory, disk memory, tape memory or any suitable type of medium that enables the storage and retrieval of digital information.

The embodiment of the device 30 shown in FIG. 2 should be viewed as representing any type of device that includes some means for displaying information to a user, and that has the ability to access remotely stored or generated information for display. Embodiments of the device 30 may include, as non-limiting examples, personal computers, workstation computers, portable computers such as notebooks and laptops, personal digital assistants (PDAs) and organizers, handheld communication devices such as cellular phones, music playback devices, gaming devices, Internet browsing appliances, and combinations of same, as well as other types of devices that incorporate one or more such devices, such as a television having a network interface 36 and a browsing capability.

At least the display 10, pointing device 15 (if present), and the data processor 32 operating under control of at least a portion of the program instructions 34A, as well as the portion of the memory 34 that stores the forward list 34A, may be considered to form a user interface (UI) that operates in accordance with the exemplary embodiments of this invention.

The network interface 36 is one that is suitable for use in accessing the network 38, and may be based on the reception and transmission of optical signals through space or through an optical fiber, on the reception and transmission of radio frequency signals through space or through a cable, and on the reception and transmission of electrical signals sent and received through one or more wires. In some embodiments the network interface 36 with comprise a radio frequency transceiver adapted for use in a cellular communication system, such as a time divisional multiple access (TDMA) system such as one known in the art as GSM, or a code division multiple access (CDMA) system such as one known as cdma2000, or as a wideband CDMA (WCDMA) single carrier or multi-carrier system. In one non-limiting embodiment the device 30 may be a cellular phone or terminal.

Note that while the exemplary embodiments of this invention are primarily described in the context of the browser application 34A′, the use of the exemplary embodiments is not limited thereto, as other types of systems, applications and devices may benefit, such as file management applications.

In the exemplary embodiments of this invention the browser application 34A′ (assumed for convenience to be part of the program instructions 34A) stores information in the forward list 34B concerning the movement from one page to another (where the movement occurs using page links). Based on the information stored in the forward list 34B the browser application 34A′ determines which page Y is most often opened after the user visits page X. In accordance with the exemplary embodiments, the user is enabled to activate the forward button 22 to enter a web page that (historically) is the one most often opened after the user has visited the current page (page X).

It can be noted that more intelligent techniques may be used for selecting a page or pages linked to the forward 22. For example, the device 30 may store an indication of user behavior and, according to the stored behavior-related information, define the next page or application state. For example, assume that a user every morning goes to a news web page and checks sports results, and later in the day goes to the same news web page to check economic data. In this case the device 10 may store the user's browser usage behavior as a function of the time of day, and define the forward button linking accordingly.

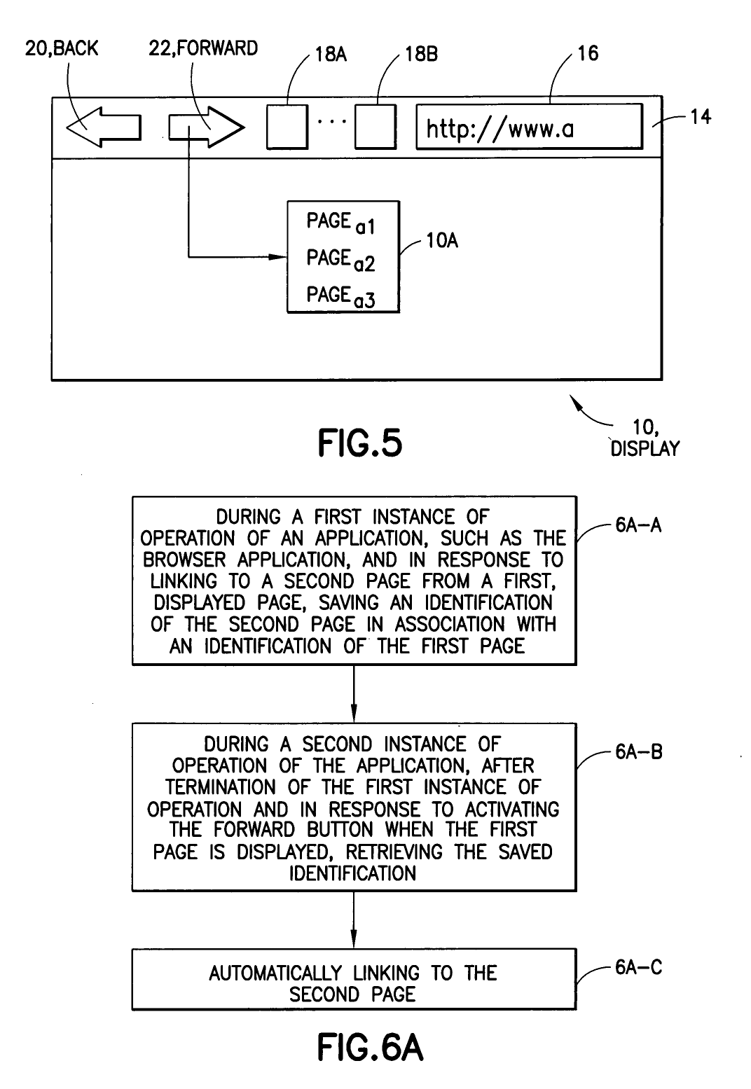

Referring to FIG. 3, there is shown a first embodiment of the forward list 34B. In this embodiment the browser application 34A′ saves information concerning a page that the user has moved to after visiting a first page. In FIG. 3 the forward list 34B can be seen to comprise a data structure having a list of visited pages 35A (e.g., Pageₐ, Page_{b}, . . . Page_{z}), and associated with each is a next page 35B (e.g., Pageₐ₁, Page_{b1}, . . . Page_{z1}) to which the user has navigated from the visited page. For example, assume that the user visits at least once the web page www.nokia.com, and that from this page the user links or points to a product page. According to collected information the browser application 34A′ is enabled to define that the product page is visited the most often after the user has visited www.nokia.com. In this case then, and in response to the user activating the forward button 22 (note that mouse gestures may be used for this purpose) when viewing the web page www.nokia.com, the browser application 34A′ accesses the forward list 34B, finds the entry for the current web page in the list 35A, retrieves the corresponding web page identification from the list 35B, and automatically accesses and opens the Nokia product page.

Note that the exemplary embodiments of this invention, and in particular the use of the enhanced forward button 22 functionality, can be used to great advantage when navigating through web pages, in that it saves time when moving from page to page, and furthermore aids the user in quickly locating a page or pages that were previously navigated to and which may thus be considered to be of at least some interest to the user.

Note also that the browser application 34A′ may also preload (prefetch) at least one next expected page in anticipation of the user activating the forward button 22.

Referring to FIG. 4, there is shown a second embodiment of the forward list 34B. In this embodiment the browser application 34A′ saves information concerning a plurality of pages that the user has moved to after visiting a first page. In FIG. 4 the forward list 34B can be seen to comprise a data structure having the list of visited pages 35A as in the embodiment of FIG. 3 (e.g., Pageₐ, Page_{b}, . . . Page_{z}), and associated with each is a plurality of next pages 35B. For example, for the web page Pageₐ there is some number (at least one, up to some maximum number such as three) of next pages that the user has navigated from the visited page (e.g., Pageₐ₁, Pageₐ₂, Pageₐ₃, and note that these pages may also be accessible via shortcut keys). For example, assume that the user visits at least once the web page www.nokia.com, and that from this page the user has in the past linked to a product page (Pageₐ₁), to a retailer location page (Pageₐ₂) and to an accessories page (Pageₐ₃). The linked-to pages 35B may be ordered by frequency of use, or by the most recently linked-to page, as two non-limiting examples. To facilitate this there may be related information 35C provided with each linked-to page, and this related information 35C can include, as non-limiting examples, one or more of a count of the number of times this page has been linked to, a data and time that this page was last linked to, as well as any other information that may be useful for the browser application 34A′ to manage the forward list 34B to add a new linked-to page and/or to replace an existing linked-to page with another, as well as to order the entries in the forward list 34B for display to the user, as described below.

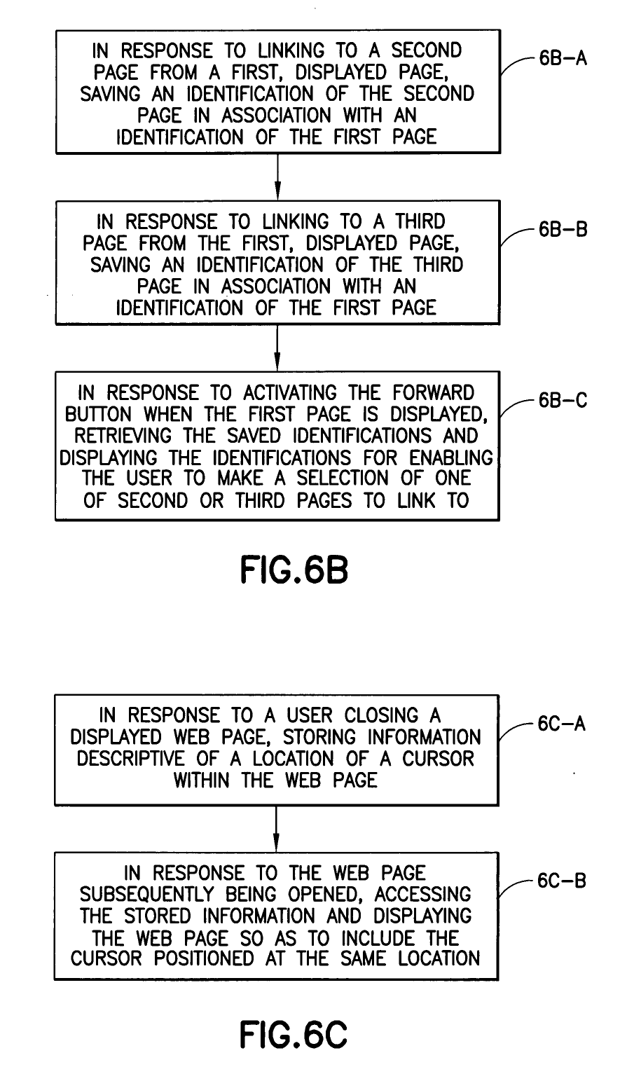

In the embodiment of FIG. 4, and in response to the user activating the forward button 22 when viewing the current web page (e.g., www.nokia.com), the browser application 34A′ accesses the forward list 34B, finds the entry for the current web page in the list 35A, retrieves the corresponding web page identification(s) from the list 35B, and displays, as shown in FIG. 5, the corresponding web page identification(s) to the user, such as in a drop down box or drop down list 10A that includes the pages where user has most often moved from the current web page. The displayed pages may be listed in the order of most accessed pages, or by the most recently accessed pages, as two non-limiting examples. By then clicking on or otherwise selecting one of the displayed linked-to pages the user is enabled to quickly navigate to the next page of choice. In response, the browser application 34A′ updates the related information 35C as appropriate.

Note that in the embodiment of FIG. 4, and if there is only one entry in the linked-to page list 35B, then the browser application 35A may default to the embodiment of FIG. 3 and automatically link to the associated linked-to page 35B, without displaying the drop down list 10A.

Note further that the operation of the browser application 34A′ in conjunction with the forward list examples 34B of FIGS. 3 and 4 may be selectively turned on and off by the user. If turned off then activation of the forward button 22 may be conventional in nature. However, even if disabled the browser application 34A′ may still operate to populate and manage the forward list 34B of FIGS. 3 and 4 such that when the user enables this functionality, the browser application 34A′ is able to immediately begin operation to, upon a next activation of the forward button 22, either automatically access a last accessed linked-to page as in FIG. 3, or to present the drop down list 10A to the user as in FIG. 4.

Note also that the related information 35C can also be used by the browser application 34A′ to manage the forward list 34B, such as to periodically remove entries that have not been accessed for some period of time.

Note further that additional intelligence may be incorporated into the related information 35C and the application that creates and maintains it. as one example, if the user moves from page X to page Y by pressing forward button 22, and then moves quickly back to page X with the back button 20, there is a strong indication that page Y was not the page that the user actually wished to view after viewing page X. In this case the device 10 may detect this behavior pattern and not increase the counter of the related information 35C in response to the user originally moving from page X to page Y.

As can be appreciated, the number of entries 35A and/or 35B in the forward list 34B for either of the FIGS. 3 and 4 is subject to any of a number of user interface and/or underlying hardware (e.g., memory capacity and/or display screen area) constraints. The specific examples shown (e.g., the storage and display of up to three previous forward linked-to web pages as in FIG. 4) are thus not intended to be limiting in any way. For example, if the screen area is large one might wish to display to the user the previous 25 pages that were linked to from the currently displayed web page. Alternatively, even if the display screen area is limited, one may provide the drop down list 10A so as to have a scroll capability to enable the user to view and select from any number of pages that were previously linked to from the currently displayed web page. Note in this regard that the user may be provided with thumbnail views of the pages that were previously linked to.

As an alternative user interface feature, as opposed to showing only the next level of pages that the user might wish to visit, as in the drop down list 10A, multiple levels of pages may be displayed. For example, what may be displayed are pages Y1-Y3 that are most probably visited after page X, as well as pages Z1-Z3 that are most likely to be visited after pages Y1-Y3. Activating the forward button 22 in this case may then open and display, for example, a hierarchical tree view of potential pages. In this case the hierarchical tree view may also present thumbnail views of the pages.

The actual data stored in the forward list 34B can include uniform resource locators (URLs) descriptive of web page addresses, as well as textual information providing a web page description (e.g., Products, Accessories, etc.) that would be more appropriate for display to the user in the drop down box 10A.

In accordance with a further embodiment the web page itself may store the information concerning the page or pages that are most visited (by a number of users that visit the page). In this embodiment a page (or pages) defined to be opened after the activation of forward button can be defined by all users that visit a certain web page, and not a single user. Note that different user groups may be used. For example, a user may define his user profile, or the application may define to which user group user belongs to. In this case, when the user belonging to certain user group views a web page, the page(s) linked to the forward button 22 can be defined according to user's user group information, as opposed to globally across all users.

According to a still further embodiment, a creator of the web page (e.g., the web page designer) defines at least one page ( a target page) that is linked to after activation of the forward button 22. For example, the home page owner can define that activation of the forward button 22 in the owner's home page takes the user automatically to the owner's product page, or as another non-limiting example activation of the forward button 22 in the owner's home page takes the user automatically to the owner's on-line reservation page (e.g., for a case of a hotel or an airline).

Note that in these cases the exemplary embodiments of this invention may not be implemented solely as part of the browser application 34A′, but instead may be implemented at least in part by software running at one or more of the servers 40A, 40B shown in FIG. 2. In general, the information related to usage of the forward button 22 may be distributed between user devices 10 and various servers 40A, 40B located in the network 38.

Various ones of the foregoing embodiments may be implemented with HTML or similar programming well known in the art by those of ordinary skill, when guided by the description of the exemplary embodiments herein.

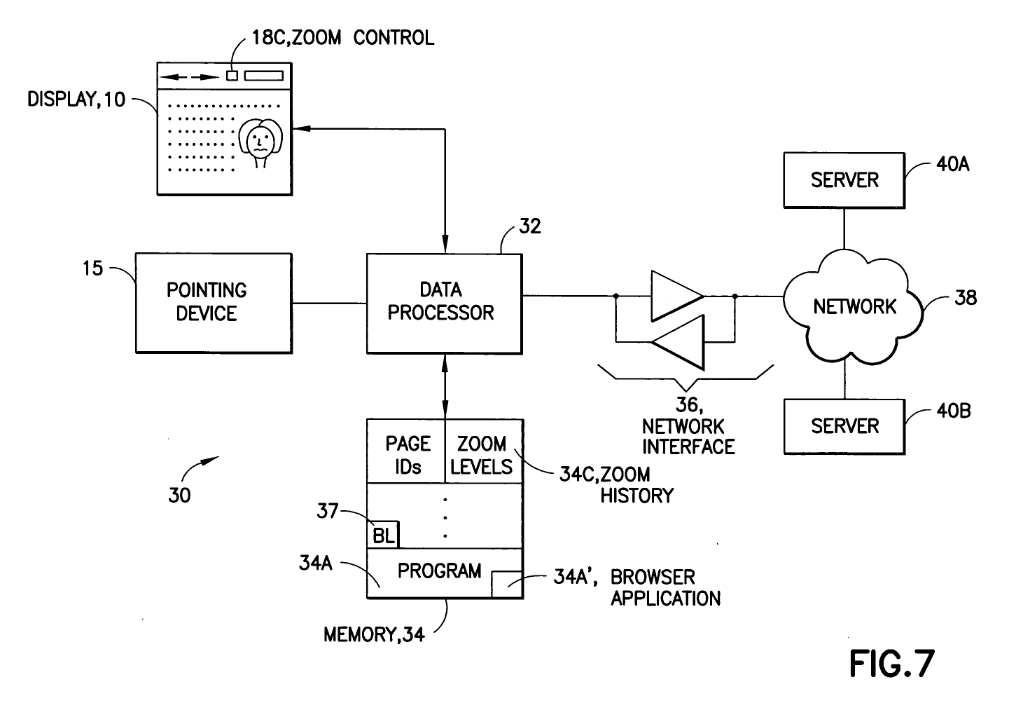

Referring to FIG. 6A, based on the foregoing it can be appreciated that in one embodiment a method operates (Block 6A-A) during a first instance of operation of an application, such as the browser application 34A′, and in response to linking to a second page from a first, displayed page, to save an identification of the second page in association with an identification of the first page. Then, (Block 6A-B) during a second instance of operation of the application, after termination of the first instance of operation (e.g., closing the browser application 34A′, and then subsequently opening it again), and in response to activating the forward button 22 when the first page is displayed, the method operates to retrieve the saved identification and, at Block 6A-C, to automatically link to the second page. That is, by the use of the forward list 34B, the browser application 34A′ is enabled to “remember” the user's previous forward link selection (e.g., a web page or portion of a web page) from a previous instance of browser application operation, and to automatically link to the previous link choice without requiring the user to once again manually link to the previous link choice.

Further by example, the exemplary embodiments of this invention can be employed in file management systems where a user moves in a file folder hierarchy so as to enable the user to automatically access a file or file folder that was last accessed from a current file or file folder.

It should be further noted that the usage of the forward button 22 may be extended for use with mobile applications, such as when the user moves normally from one application to another. In this case a forward button functionality may be defined that takes the user to a next application or application state according to stored data that indicates (historically) which application state is most probably entered by the user after a current application state.

It should also be noted that the linking does not have to be between two of the same class of information types (e.g., web page to web page). As non-limiting examples, a forward button used in a file manager application may take the user to a web page, or a forward button activation in a browser application may take user to a mobile game application.

As can be appreciated, the use of the exemplary embodiments of this invention beneficially increases the usability of a web page, since the forward button 22 is provided with enhanced functionality as compared to the current and conventional use of the forward button 22.

Referring to FIG. 6B, a method in accordance with the exemplary embodiments of this invention includes (Block 6B-A), in response to linking to a second page from a first, displayed page, saving an identification of the second page in association with an identification of the first page; (Block 6B-B) in response to linking to a third page from the first, displayed page, saving an identification of the third page in association with an identification of the first page; and (Block 6B-C) in response to activating the forward button 22 when the first page is displayed, retrieving the saved identifications and displaying the identifications (such as in the drop down box 10A) for enabling the user to make a selection of one of the second or third pages to link to.

In the method the pages may comprise web pages, or they may comprise at least one of files and file folders, as two non-limiting examples.

Various modifications and adaptations may become apparent to those skilled in the relevant arts in view of the foregoing description, when read in conjunction with the accompanying drawings and the appended claims.

As one example, the forward button 22 may cause linking to a different page according to the user's location on a page. Note that one certain page can include different kinds of information and links to totally different pages. In this case, if the user were scrolling sport news in a news page activation of the forward button 22 may take the user to page X, while if the user is scrolling the business news section, activation of the forward button 22 may take the user to a page Y.

As a further example, the conventional behavior of the forward button 22 and the new enhanced behavior in accordance with the exemplary embodiments of this invention may both be accommodated. For example, the conventional functionality may be used if the user activates forward button 22 with a brief press (e.g., touches the touch sensitive display 10 screen for one second or less), while if the forward button 22 is pressed longer, then the enhanced functionality described herein is employed.

As a further example, the forward button 22 may provide linkage to those pages that can be accessed directly from the current page, or the forward button 22 may provide linkage to pages that are not linked from the current page but that are inserted into the address field 16 by the user.

As a further example, the activation of the forward button 22 may not take the user to another page or view, but may instead take the user to another part of the same web page, such as moving the user to a sports section of a longer news-related page.

All such and similar modifications of the exemplary embodiments of this invention are intended to fall within the scope of this invention.

Further in accordance with the exemplary embodiments of this invention, the browser application 34A′ may provide additional functionality. For example, the browser application 34A′ may provide an ability to perform at least one of: (A) storing a previous zoom level for previously visited web pages, (B) making an intelligent font size selection for a web page, and (C) storing one or more cursor positions for previously visited web pages.

(A) Storing the Previous Zoom Level

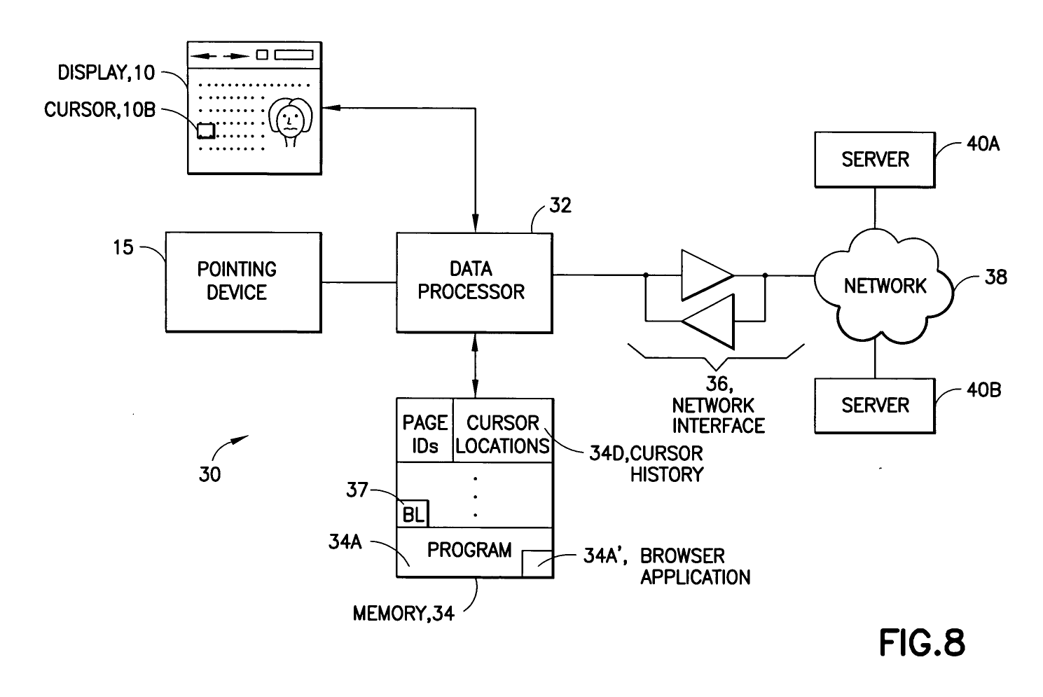

Referring to FIG. 7, in this embodiment the browser application 34A′ responds to the user visiting a web page, and changing a zoom level on the web page, such as by using a zoom control button 18C, to store in a zoom history file 34C the resulting (final) zoom level together with an identification (e.g., the URL) of the web page (Page_ID). This embodiment may operate only with URL's stored in a bookmark list (BL 37). In this case the zoom level information may be stored in the BL 37, obviating the need for the zoom history file 34C. Alternatively, the zoom history file 34C is used to buffer some number (e.g. the last 10-100) URLs where the user has manually adjusted the zoom level of the web page.

When the user subsequently visits a web page having a URL stored in the zoom history file 34C (or in the bookmarks list 37) the browser application 34A′ automatically sets the zoom control 18C to the previous zoom level when presenting the web page on the display 10.

Note that if the user happens to adjust the established zoom level while viewing the web page, then the browser application 34A′ preferably updates the zoom level stored in the zoom history file 34C (or in the bookmarks list 37).

As a non-limiting example, this approach can be useful if the user periodically visits a web page containing airline or train schedules, as the user need not manually re-size/zoom the web page at each visit as the user is automatically provided with the last zoom level used on that particular web page.

Note that this embodiment may operate with just a portion of a web page (e.g., just with the portion of the page having the actual scheduling information), and may not apply the zoom to the entire page. That is, the Page_ID stored in the zoom history 34C may identify a portion (or portions) of a web page where the zoom is to be applied

(B) Intelligent Font Size Selection for a Web Page

In this embodiment the user may also/instead be enabled to define that the web page layout be automatically adapted to the screen of the display 10.

The user may be provided the following options as a setting:

web page zoom level

(a) last-used zoom level (as described above, this may be a default state);

(b) set zoom level according to readability;
(b1) small font
(b2) medium font
(b3) large font

(c) full width of web page on screen;

(d) entire web page on screen.

By selecting sub-option (b) “set zoom level according to readability”, the browser application 34A′ operates for all web pages that are visited to automatically adapt the zoom level according to the fonts available on the visited web page. For example, selecting ‘large font’ setting results in automatically increasing the zoom level of a web page being visited until the (smallest) fonts displayed reach a size of, for example, 4-5 mms in height on the actual display screen.

Since a particular web site may contain a number of texts in different fonts, the zoom level is preferably adaptive when scrolling through the web page, thereby ensuring that the smallest specified font currently to be displayed is increased to fit the 4-5 mm height setting.

(C) Storing the Cursor Position(s) of Each Visited Web Page

A further issue that can arise when browsing web pages on a small area display, such as the display 10 when implemented in a portable, handheld communication device, is that the user may be required to perform a number of scrolling operations (e.g., using a scroll button or a pointing device such as a mouse, if supported) to locate the information needed by the user.

In accordance with a further exemplary embodiment of this invention, and referring to FIG. 8, the browser application 34A′ responds to the user visiting a web page to store in a cursor history file 34D the final location of the cursor 10B together with the Page_ID (e.g., the URL) of the web page. As with the embodiment of FIG. 7, this embodiment may operate only with URL's stored in the bookmark list (BL 37), thereby obviating the need for the cursor history file 34D. Alternatively, the cursor history file 34D is used to buffer some number (e.g. the last 10-100) URLs in association with a last location of the on-screen cursor 10B.

When the user subsequently visits a web page having a URL stored in the cursor history file 34D (or in the bookmarks list 37) the browser application 34A′ automatically sets the location of the cursor 10B to the indicated location when presenting the web page on the display 10, thereby relieving the user from having to manually scroll to the desired location in the web page.

A typical use case can be similar to that noted above, i.e., the user periodically visits a web page to check a train schedule. Assuming that the schedule is placed such that the user is required to scroll (or page down) to locate it, by the use of this embodiment the web page is entered and initially displayed to the user so as to include the last location of the cursor during a previous visit, thereby saving the user from having to manually scroll.

It should be noted that this latter embodiment can be combined with the embodiment of FIG. 7 to also apply a last-used zoom level to ensure that the desired information is displayed in a format that is easily readable by the user. For such combined operations it is possible to combine the functionality of the zoom history list 34C and the cursor history list 34D into one unified list or data structure.

It should be further noted that one or both of the embodiments of FIGS. 7 and 8 can be combined with the embodiments of FIGS. 2-6. In this case the related information 3 5C of the forward list 34B may include, on a per page basis, a last used zoom level, and/or desired font size information, and/or a last cursor location. Alternatively, separate lists can be maintained in the memory 34 for these various types of information.

As one non-limiting example, in response to the user selecting a web page from the drop down list 10A of Figure S, the browser application 34A′ may access the web page (if not already preloaded or prefetched) and display the web page (or a portion of the page) using the last-used zoom level and/or at the last-used location of the cursor 10B.

The use of the exemplary embodiments described above can be particularly helpful with a communications-based device 10 such as when operating a short message service (SMS) viewer and/or editor, or when viewing a calendar.

Referring to FIG. 6C, it can thus be appreciated that the exemplary embodiments of this invention further provide a method that includes (Block 6C-A), in response to a user closing a displayed web page, storing information descriptive of a location of a cursor within the web page; and (Block 6C-B) in response to the web page subsequently being opened, accessing the stored information and displaying the web page so as to include the cursor positioned at the same location.

The method may further include, in response to the web page subsequently being opened, accessing other stored information and displaying the web page to have a same zoom factor as when the web page was previously closed and/or to have a same character size as when the web page was previously closed.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

In all of the foregoing exemplary embodiments of this invention it should be appreciated that their use is not limited to a user device, such as the device 10, and that internet-based services and servers may also employ the exemplary embodiments of this invention.

It should also be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSHI, or the like) may be transmitted to a semiconductor fabrication facility for fabrication as one or more integrated circuit devices.

It should be noted that some of the features of the examples of this invention maybe used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
during a first instance of operation of an application, and in response to linking to a second page from a first, displayed page, saving an identification of the second page in association with an identification of the first page; and
during a second instance of operation of the application, after termination of the first instance of operation, and in response to activating a forward button when the first page is displayed, retrieving the saved identification and automatically linking to the second page.

2. The method of claim 1, performed in a handheld device having wireless communication capability.

3. The method of claim 1, performed in a server that is configured to receive through a network an indication of activating the forward button.

4. The method of claim 1, where automatically linking further comprises displaying the second page and automatically establishing at least one of a zoom factor, a character size and a cursor location of the displayed second page based on information saved with the identification of the second page.

5. A method, comprising:
in response to linking to a second page from a first, displayed page, saving an identification of the second page in association with an identification of the first page;
in response to linking to a third page from the first, displayed page, saving an identification of the third page in association with an identification of the first page; and
in response to activating a forward button when the first page is displayed, retrieving the saved identifications and displaying the identifications for enabling a selection of one of the second or third pages to link to.

6. The method of claim 5, where the identifications are displayed in a predetermined order.

7. The method of claim 6, where the predetermined order is one based on at least a number of times that each of the second and third pages has been previously linked to.

8. The method of claim 5, performed in a handheld device having wireless communication capability.

9. The method of claim 5, performed in a server that is configured to receive through a network an indication of activating the forward button.

10. The method of claim 5, where at least one of the steps of saving an identification of the second and third pages comprises saving in association with at least one of the identifications of the second and third pages other information descriptive of at least one of a zoom factor, a character size and a cursor location associated with the at least one of the second and third pages.

11. An apparatus, comprising:
a display;
a memory;
a network interface; and
a data processor configured to operate under control of a stored program to display information on the display, the information comprising at least pages received through the network interface, said data processor further configured to store in the memory, in association with an identification of a first page, an identification of each of a plurality of second pages that are linked to from the first page, and, in response to an activation of a forward control when the first page is displayed, to display at least some of the saved identifications for enabling a selection of one of the plurality of second pages to link to.

12. The apparatus of claim 11, where the second page identifications are displayed in a predetermined order.

13. The apparatus of claim 12, where the predetermined order is one based on at least a number of times that each of the plurality of second pages has been previously linked to.

14. The apparatus of claim 11, embodied in a handheld device having wireless communication capability.

15. The apparatus of claim 11, where at least said data processor is embodied in a server that provides pages for display through a network.

16. The apparatus of claim 11, where the data processor further stores in the memory, in association with the identification of at least one of the plurality of second pages, other information descriptive of at least one of a zoom factor, a character size and a cursor location associated with the at least one of the plurality of second pages.

17. A computer program product embodied in a tangible memory medium and comprising program instructions that when executed by a data processor result in operations that comprise:
in response to linking to individual ones of a plurality of second pages from a first, displayed page, saving an identification of each of the plurality of second pages in association with an identification of the first page; and
in response to subsequently activating a forward button when the first page is displayed, displaying at least some of the saved identifications for enabling a selection of one of the plurality of second pages to link to.

18. The computer program product of claim 17, where the plurality of second page identifications are displayed in a predetermined order.

19. The computer program product of claim 18, where the predetermined order is one based on at least a number of times that the user has linked to each of the plurality of second pages.

20. The computer program product of claim 17, where the at least some of the plurality of second page identifications are displayed in a drop down box to the user.

21. The computer program product of claim 17, where the operations are performed in a handheld device having wireless communication capability.

22. The computer program product of claim 17, where the operations are performed in a server that is configured to receive through a network an indication of a user activating the forward button.

23. The computer program product of claim 17, where the operation of saving stores in the memory, in association with the identification of at least one of the plurality of second pages, other information descriptive of at least one of a zoom factor, a character size and a cursor location associated with the at least one of the plurality of second pages.

24. A user interface, comprising:
means for displaying pages to a user;
means for storing an identification of a plurality of second pages in association with an identification of a first page, where the plurality of second pages are those previously linked to from the first page; and
means, responsive to activation of a forward button when the first page is displayed, for accessing said storing means to retrieve the identifications of the plurality of second pages and for displaying at least some of the identifications using said displaying means.

25. The user interface of claim 24, comprising a part of a wireless communication device.

26. The user interface of claim 24, where said accessing and displaying means displays said at least some of the identifications in an order based on a number of previous links to each of the plurality of second pages.

27. The user interface of claim 24, where at least some of said pages comprise web pages.

28. The user interface of claim 24, further comprising means for saving, in association with the identification of at least one of the plurality of second pages, other information descriptive of at least one of a zoom factor, a character size and a cursor location associated with the at least one of the plurality of second pages.

29. A method, comprising:
in response to each access of different ones of second information items from a first, displayed information item, saving an identification of each of the second information items in association with an identification of the first information item; and
in response to activation of a forward user interface control when the first information item is displayed, displaying saved identifications for enabling a selection to be made of one of the second information items.

30. The method of claim 29, where at least one of the first and second information items comprise web pages.

31. The method of claim 29, where at least one of the first and second information items comprise at least one of files and file folders.

32. The method of claim 29, performed in a user device.

33. The method of claim 29, performed in a server coupled to a network.

34. The method of claim 29, where at least one of the second information items is accessed by a user entering a network address of the second information item.

35. The method of claim 29, further comprising selecting one second information item from a displayed list comprised of a plurality of second information items.

36. The method of claim 29, where displaying comprises a hierarchical tree structure.

37. The method of claim 29, further comprising selecting one of a plurality of second information items to automatically link to based at least in part on a time of day.

38. The method of claim 29, further comprising selecting one of a plurality of second information items to automatically link to based at least in part on past behavior of a user when accessing the second information item from the first, displayed information item.

39. The method of claim 29, where at least one of the first and second information items comprise at least one of applications and application states.

40. The method of claim 29, further comprising linking to one of the second information items in response to activation of the forward user interface control for at least a predetermined period of time.

41. The method of claim 29, further comprising initially prefetching all or a part of at least one second information item when the first information item is displayed.

42. The method of claim 29, further comprising selecting one of the plurality of second information items to automatically link to based at least in part on a classification of a user into one of a plurality of user groups.

43. The method of claim 29, where saving an identification of the second information item in association with an identification of the first information item selects the second information item whose identification is saved based at least in part on choices of second information items made by a plurality of users.

44. The method of claim 29, where saving an identification of the second information item in association with an identification of the first information item is performed only if a user does not activate a back user interface control within some predetermined period of time after accessing the second information item.

45. The method of claim 29, where the second information item is a portion of a same web page that contains the first information item.

46. The method of claim 29, where there are a plurality of identifications of second information items saved in association with the identification of the first information item, further comprising in response to a user activating the forward user interface control, displaying to the user at least some of the plurality of saved identifications of second information items to enable the user to select one of the plurality of second information items to automatically link to.

47. The method of claim 46, where displaying comprises displaying the at least some of the plurality of saved identifications in the form of an ordered list.

48. The method of claim 46, where displaying comprises displaying the at least some of the plurality of saved identifications in the form of a hierarchical tree structure.

49. The method of claim 29, where saving further comprises storing, in association with the identification of at least one of the plurality of second information items, other information descriptive of at least one of a zoom factor, a character size and a cursor location associated with the at least one of the plurality of second information items.

50. A memory device that stores data in the form of a data structure comprising at least one identification of a web page, associated with said at least one identification a plurality identifications of web pages or portions of web pages previously linked to from the web page, and additional information associated with each of the plurality of identifications for use when displaying said plurality of identifications in response to activation of a forward button.

51. The memory device of claim 50, where the additional information comprises a count of a number of times that an associated one of the web pages or portion of the web page has been previously linked to.

52. The memory device of claim 50, where the additional information comprises a time and date that an associated one of the web pages or portion of the web page was previously linked to.

53. The memory device of claim 50, where the additional information comprises at least one of information descriptive of at least one of a zoom factor, a character size and a cursor location associated with the at least one of the plurality of second pages.

54. A method, comprising:
in response to a user closing a displayed web page, storing information descriptive of a location of a cursor within the web page; and in response to the web page subsequently being opened, accessing the stored information and displaying the web page so as to include the cursor positioned at the same location.

55. The method of claim 54, where in response to the web page subsequently being opened, accessing other stored information and displaying the web page to have a same zoom factor as when the web page was previously closed.

56. The method of claim 54, where in response to the web page subsequently being opened, accessing other stored information and displaying the web page to have a same character size as when the web page was previously closed.

57. The method of claim 54, executed in a portable device that comprises communication circuitry.
